(19) United States
(12) Patent Application Publication
(10) Pub. No.: US 2015/0104708 A1
(43) Pub. Date: Apr. 16, 2015

(54) OXIDE CATHODE MATERIAL FOR LITHIUM ION BATTERY HAVING HIGH ENERGY DENSITY AND PREPARATION PROCESS THEREOF

(71) Applicants: NINGBO INSTITUTE OF MATERIALS TECHNOLOGY & ENGINEERING, CHINESE ACADEMY OF SCIENCES, Ningbo (CN); NINGDE CONTEMPORARY AMPEREX TECHNOLOGY LIMITED

(72) Inventors: Yujing BI, Ningbo (CN); Deyu WANG, Ningbo (CN); Jun LI, Ningbo (CN)

(21) Appl. No.: 14/579,824

(22) Filed: Dec. 22, 2014

Related U.S. Application Data
(63) Continuation of application No. PCT/CN2012/078726, filed on Jul. 16, 2012.

(30) Foreign Application Priority Data
Jun. 21, 2012 (CN) 201210211960.3

(51) Int. Cl. H01M 4/36; H01M 10/0525; H01M 4/505; H01M 4/485; H01M 4/525

(52) U.S. Cl. CPC H01M 4/366; H01M 4/485; H01M 4/525; H01M 4/505; H01M 10/0525; H01M 2004/028
USPC 429/220; 429/223; 429/221; 264/618

(57) ABSTRACT

Provided are a high energy density oxide anode material for lithium ion battery, preparation process and use thereof. Said anode material includes a main part of the anode material and a covering layer. Said main part includes a shell and a core inside the shell. The material of said core is Li₁₊ₓ[Ni_{1-y-z}Co_{y}Mn_{z}]O₂ wherein −0.1≦x≦0.2, 0≦y≦0.5, 0≦z≦0.5 and 0≦y+z≦0.7. The material of said shell is Li₁₊ₐ[Co_{1-b}X_{b}]O₂, wherein −0.1≦a≦0.2, 0≦b≦0.5, and X is selected from Al, Mg, Cu, Zr, Ti, Cr, V, Fe, Mn, Ni, or combination thereof. Otherwise, The material of said main part is a mixture of Li₁₊ₓ[Ni_{1-y-z}Co_{y}Mn_{z}]O₂ and LiCoO₂, wherein −0.1≦x≦0.2, 0≦y≦0.5, 0<z≦0.5 and 0≦y+z≦0.7. The material of said covering layer is selected from Al₂O₃, ZrO₂, MgO, SiO₂, ZnO₂, TiO₂, Y₂O₃, LiAlO₂, or combination thereof. Said anode material has the advantages of high capacity, good cycle performance, low surface activity, high voltage resistance and fine safety. The preparation process is simple, and is suitable for large-scale production.

### TECHNICAL FIELD

The invention relates to the field of energy materials, in particular to a cathode material for lithium ion battery having high energy density and the method for preparation thereof.

### BACKGROUND ART

With its advantages of high energy density, good cycle performance, low self-discharge rate and good environmental compatibility, lithium ion secondary battery is an ideal energy storage system and has developed rapidly in the field of various consumer electronics as well as shown great potential in the field of electric tools, electric vehicles and power energy storage.

High capacity cathode material is the basis and key for developing high energy density lithium ion battery thus has become the research focus of the world in recent years. Nickel-based material has significant cost effectiveness. The capacity of material can be obviously enhanced with the increase of the amount of nickel, for example, the NCA in 4.25 V can achieve 180 mAh/g. However, high nickel cathode material with high surface activity can easily have side reaction with electrolyte which leads to battery bilge gas. Therefore it is necessary to have these cathode materials modified.

Forming core-shell structure is an effective method for modification. The overall performance of the material can be improved by forming a shell which is more stable than the matrix outside the core particle. Moreover, the safety performance can be greatly improved by applying a coating layer to the particle. At present, the major studies on the cathode material with core-shell structure remain in using high-manganese material as shell. Novel cathode material yet needs to be developed in the art.

### SUMMARY OF THE INVENTION

The object of the invention is to provide a novel oxide cathode material for lithium ion battery having high energy density and the method for preparation thereof.

In the first aspect of the present invention, a cathode material is provided. Said cathode material comprises an cathode material body and a coating layer located on the surface of the cathode material body,
wherein, the material of the coating layer is Al₂O₃, ZrO₂, MgO, SiO₂, ZnO, TiO₂, Y₂O₃, LiAlO₂, or the combination thereof;
said cathode material body includes a shell and a core inside the shell, wherein the core material is Li₁₊ₓ[Ni_{1-y-z}Co_{y}Mn_{z}]O₂, wherein, −0.1≦x≦0.2, 0≦y≦0.5, 0≦z≦0.5 and 0≦y+z≦0.7; the shell material is Li₁₊ₐ[Co_{1-b}X_{b}]O₂, wherein −0.1≦a≦0.2, 0≦b≦0.5, and X is Al, Mg, Cu, Zr, Ti, Cr, V, Fe, Mn, Ni, or the combination thereof; or
alternatively, said cathode material body is a mixture of Li₁₊ₓ[Ni_{1-y-z}Co_{y}Mn_{z}]O₂ and LiCoO₂, wherein, −0.1≦x≦0.2, 0≦y≦0.5, 0≦z≦0.5 and 0≦y+z≦0.7.

In another preferred embodiment, when the shell material is Li₁₊ₐ[Co_{1-b}X_{b}]O₂, wherein −0.1≦a≦0.2, and X is the combination of two or more of Al, Mg, Cu, Zr, Ti, Cr, V, Fe, Mn and Ni, each b independently is as follows: 0≦b≦0.5.

In another preferred embodiment, x=0.

In another preferred embodiment, a=0.

In another preferred embodiment, the lattice structures of the core material and the shell material are α-NaFeO₂, and the space groups thereof are R-3m.

In another preferred embodiment, both the core material and the shell material have ion insertion and de-insertion ability.

In another preferred embodiment, the ratio of the thickness of the shell and the radius of the cathode material particular is about 0.005-0.5; and/or the thickness of the coating layer is 0.2-50 nm.

In another preferred embodiment, the amount of Ni in the core material is more than that in the shell material, and the amount of Co in the core material is less than that in the shell material.

In another preferred embodiment, said core consists of crystalline grain with 0.1-5 μm, and said shell consists of crystalline grain with 0.1-5 μm.

In the second aspect of the present invention, a method for the preparation of said cathode material in the first aspect is provided, including the following steps:
(a) precipitating the hydroxide of cobalt or that of X and cobalt on the surface of Ni_{1-y-z}Co_{y}Mn_{z}(OH)₂ to obtain a core-shell precursor P;
(b) mixing the core-shell precursor P with a lithium source at the mole ratio of Li/P=1-1.2 and then sintering the mixture;
(c) precipitating the hydroxide of metal M on the surface of the sintered material;
(d) sintering at 200-1000 ° C. for 0.5-24 h to obtain the cathode material,
wherein, 0≦y≦1.0, 0≦z≦1.0, 0≦y+z≦1, and 0≦b≦1.0;
X and M independently selected from one of Al, Mg, Cu, Zr, Ti, Cr, V, Fe, Mn, Ni, Y, Zn or the combination thereof.

In another preferred embodiment, in step (c), the sintered sample is placed in a buffer solution, a salt solution of said metal M is added and the pH value is adjusted to alkalinity, and the hydroxide of metal M is precipitated on the surface of the sintered sample.

In another preferred embodiment, the buffer solution is one of acetic acid-sodium acetate, acetic acid-potassium acetate, acetic acid-lithium acetate, ammonia-ammonium chloride, aqueous ammonia, ammonium acetate-sodium acetate, acetic acid, ammonia-sodium hydroxide, ammonia-potassium hydroxide, phosphate buffer solution, borate buffer solution or the combination thereof, and the pH of the buffer solution is 4.0-14.0.

In the third aspect of the present invention, a method for the preparation of said cathode material of the first aspect is provided, including the steps:
(a) mixing Ni_{1-y-z}Co_{y}Mn_{z}(OH)₂ with Co₃O₄ to obtain a core-shell precursor P;
(b) mixing the core-shell precursor P with a lithium source at the mole ratio of Li/P=1-1.2 and then sintering the mixture;
(c) precipitating the hydroxide of metal M on the surface of sintered material;
(d) sintering at 200-1000 ° C., for 0.5-24 h to obtain the cathode material,
wherein, 0≦y≦1.0, 0≦z≦1.0, 0≦y+z≦1, and 0≦b≦1.0;
X and M independently selected from one of Al, Mg, Cu, Zr, Ti, Cr, V, Fe, Mn, Ni, Y, Zn or the combination thereof.

In another preferred embodiment, the mass ratio of Ni_{1-y-z}Co_{y}Mn_{z}(OH)₂ and Co₃O₄ is about 0.1:0.9-0.9:0.1.

In another preferred embodiment, the lithium source is one of lithium carbonate, lithium hydroxide monohydrate, lithium acetate and lithium nitrate or the combination thereof.

In another preferred embodiment, said particle size of Co₃O₄ is 0.1-5 μm.

In another preferred embodiment, in step (c), the sintered sample is placed in a buffer solution, a salt solution of M metal is added and the pH value is adjusted to alkalinity, and the hydroxide of metal M is precipitated on the surface of the sintered sample,

In another preferred embodiment, the buffer solution is one of acetic acid-sodium acetate, acetic acid-potassium acetate, acetic acid-lithium acetate, ammonia-ammonium chloride, aqueous ammonia, ammonium acetate-sodium acetate, acetic acid, ammonia-sodium hydroxide, ammonia-potassium hydroxide, phosphate buffer solution, borate buffer solution or the combination thereof, and the pH of the buffer solution is 4.0-14.0.

In the fourth aspect of the present invention, a lithium ion battery is provided, comprising of said cathode material of the first aspect.

It should be understood that, within the scope of the present invention, the technical features specifically described above and below (such as the Examples) can be combined with each other, thereby constituting a new or preferred technical solution which needs not be described one by one.

### BRIEF DESCRIPTION OF DRAWINGS

FIG. 1 is the scanning electron microscopy (SEM) photograph of core-shell precursor prepared in example 1.

FIG. 2 is the SEM photograph of cathode material prepared in example 2.

FIG. 3 is the SEM photograph of core-shell precursor prepared in example 2.

FIG. 4 is the SEM photograph of cathode material prepared in example 2.

FIG. 5 is the SEM photograph of core-shell precursor prepared in example 3.

FIG. 6 is the SEM photograph of cathode material prepared in example 3.

FIG. 7 is the internal morphology of cathode material particles prepared in example 3.

FIG. 8 is the EDS spectrogram of shell in example 3.

FIG. 9 is the EDS spectrogram of core in example 3.

FIG. 10 is the SEM photograph of cathode material prepared in example 4.

FIG. 11 is the SEM photograph of core-shell precursor prepared in example 5.

FIG. 12 is the SEM photograph of cathode material prepared in example 5.

FIG. 13 is the SEM photograph of cathode material prepared in example 6.

FIG. 14 the SEM photograph of cathode material prepared in example 7.

FIG. 15 is the XRD pattern of cathode material prepared in examples 8 and 9.

FIG. 16 is the SEM photograph of cathode material prepared in example 10.

FIG. 17 shows the result of the refined spectrogram of cathode material prepared in example 3.

FIG. 18 shows the discharge curves of the cathode materials prepared in examples 1-4.

FIG. 19 shows the discharge curves of the cathode materials prepared in examples 5, 6 and 10.

FIG. 20 shows the discharge curves of the cathode materials prepared in examples 7-9.

FIG. 21 shows the charge-discharge cycle patterns of the cathode materials prepared in example 3 and example 4.

FIG. 22 shows the charge-discharge cycle patterns of the cathode materials prepared in example 5 and example 6.

FIG. 23 shows the charge-discharge cycle patterns of the cathode materials prepared in example 7 and example 8.

FIG. 24 shows the charge-discharge cycle patterns of the cathode materials prepared in comparative example 1 and examples 11-12.

### DETAILED DESCRIPTION

Upon extensive and in-depth research, the inventors have unexpectedly developed a novel cathode material, the general performance of which can be further improved by precipitating an amorphous oxide coating layer outside the cathode material body. The cathode material according to the present invention can be used in the production of lithium ion secondary battery. Based on this, the present invention is accomplished.

Cathode Material

The cathode material according to the present invention comprises of a cathode material body and a coating layer located on the surface of the cathode material body,
wherein, the material of the coating layer is Al₂O₃, ZrO₂, MgO, SiO₂, ZnO, TiO₂, Y₂O₃, LiAlO₂, or the combination thereof;
said cathode material body includes a shell and a core inside the shell, wherein the core material is Li₁₊ₓ[Ni_{1-y-z}Co_{y}Mn_{z}]O₂, wherein, −0.1≦x≦0.2, 0≦y≦0.5, 0≦z≦0.5 and 0≦y+z≦0.7; the shell material is Li₁₊ₐ[Co_{1-b}X_{b}]O₂, wherein −0.1≦a≦0.2, 0≦b≦0.5, and X is Al, Mg, Cu, Zr, Ti, Cr, V, Fe, Mn, Ni, or the combination thereof; or
alternatively, said cathode material body is a mixture of Li₁₊ₓ[Ni_{1-y-z}Co_{y}Mnₙ]O₂ and LiCoO₂, wherein, −0.1≦x≦0.2, 0≦y≦0.5, 0≦z≦0.5 and 0≦y+z≦0.7.

Both the core and the shell of said cathode material have ion insertion and de-insertion ability. The core and the shell have same structures but different composition of elements. The shell comprising of high cobalt material leads to better electrochemical performance. The general performance of the material can be further improved by precipitating an amorphous oxide coating layer outside the shell.

The concentration of Ni gradually increases from the shell to the core, while the concentration of Co gradually decreased. Analysis of the XRD pattern of synthesized cathode material shows that the core and the shell both have a-NaFeO₂ structure and the space group thereof is R-3m. Li occupies 3a position, Ni, Co and Mn occupy 3b position and 0 occupies 3c position.

The additional characteristic of said material is that the core and the shell compose a spherical particle. Said spherical particle, the size of which is 2-50 μm, consists of crystalline grain with 0.1-2 μm.

The mass of the coating layer material accounts for 0.001-10% of the total mass of the active cathode material and the thickness of the coating layer is 0.2-50 nm. The ratio of the thickness of the shell and the radius of the spherical particular of the whole cathode material is 0.005-0.5.

Method for Preparation

The preparation of the cathode material according to the present invention comprises of the steps:
(a) precipitating the hydroxide of cobalt, or that of X and cobalt on the surface of Ni_{1-y-z}Co_{y}Mn_{z}(OH)₂ to obtain a core-shell precursor P;
(b) mixing the core-shell precursor P with a lithium source at the mole ratio of Li/P=1-1.2 and then sintering the mixture;
(c) precipitating the hydroxide of metal M on the surface of sintered material;
(d) sintering at 200-1000° C. for 0.5-24 h to obtain the cathode material,
wherein, 0≦y≦1.0, 0≦z≦1.0, 0≦y+z≦1, and 0≦b≦1.0;
X and M independently selected from one of Al, Mg, Cu, Zr, Ti, Cr, V, Fe, Mn, Ni, Y, Zn or the combination thereof.

As used herein, “the mole ratio of Li/P=1-1.2” means that the ratio of the mole of Li and the mole of the core-shell precursor is from 1 to 1.2.

According to the method for preparation in the present invention, the prepared precursor has a core-shell structure. After sintered, the particle has a shell with concentration gradient. The method for preparation in the present invention allows the material of the coating layer to uniformly attach to the surface of the core-shell material.

In one preferable embodiment, the cathode material of the present invention can be prepared by the following method:
a. adding a precursor Ni_{1-y-z}Co_{y}Mn_{z}(OH)₂ to a solvent S and stirring to form a dispersion liquid S1, wherein 0≦y≦1.0, 0≦z≦1.0, 0≦y+z≦1, and the solvent S can be one or more mixtures of water, ethanol and ethylene glycol;
b. adding a salt solution of Co or that of Co and X to S1; wherein the concentration of the salt solution of Co and X is 0 10 mol/L; the operating atmosphere can be one or more of air, nitrogen and argon; X is one or more of Al, Mg, Cu, Zr, Ti, Cr, V, Fe and Mn, the salt of which can be dissolved in the solvent S1;
c. adding an alkaline solution E while operating step b to have metal ion Co or Co and X completely precipitated, wherein the alkaline solution can be one or more of aqueous ammonia, lithium hydroxide solution, sodium hydroxide solution and potassium hydroxide solution;
d. filtering and drying to obtain a core-shell precursor P1, wherein the drying temperature is 50-200 ° C.;
e. mixing the precursor P1 for coating with a lithium salt, wherein, the mole ratio of Li/P1=1.0-1.2; the lithium salt is one or more of lithium carbonate, lithium hydroxide monohydrate, lithium acetate and lithium nitrate;

f. sintering at high temperature, especially the compound is pre-sintered at T1 and then kept at T2 for 5-50 h, wherein, T1 is 100-1000° C. and T2 is 400-1000 ° C.;
g. adding the sintered sample to a buffer solution and stirring to form dispersion liquid, wherein the buffer solution can be one or more of acetic acid-sodium acetate, acetic acid-potassium acetate, acetic acid-lithium acetate, ammonia-ammonium chloride, aqueous ammonia, ammonium acetate-sodium acetate, acetic acid, ammonia-sodium hydroxide, ammonia-potassium hydroxide, phosphate buffer solution and borate buffer solution, and the pH of the buffer solution is 4.0-14.0;
h. adding a salt solution of metal M for coating, wherein the salts of metal M, which must be dissolved in a solvent S, can be one or more of chloride, nitrate, sulfate, or acetate of Al, Mg, Zr, Si, Zn or Ti; the solvent S can be one or more of water, ethanol and ethylene glycol; the concentration of the solution of M salt is 0.01-10 mol/L;
i. adding an alkaline solution to completely precipitate the metal M, wherein the alkaline solution can be one or more of aqueous ammonia, lithium hydroxide solution, sodium hydroxide solution and potassium hydroxide solution;
j. filtering and drying, wherein the drying temperature is 50-200° C.;
k. calcinating at 300-1000° C. for 1-24 h. The weight of the coating metal salt compound accounts for 0.5-10% of the weight of lithium-containing active material.

The preparation of the cathode material according to the present invention comprises of the steps:
(a) mixing Ni_{1-y-z}Co_{y}Mn_{z}(OH)₂ with Co₃O₄ to obtain a core-shell precursor P;
(b) mixing the core-shell precursor P with a lithium source at the mole ratio of Li/P=1-1.2 and then sintering the mixture;
(c) precipitating the hydroxide of metal M on the surface of the sintered material;
(d) sintering at 200-1000° C. for 0.5-24 h to obtain the cathode material,
wherein, 0≦y≦1.0, 0≦z≦1.0, 0≦y+z≦1, and 0≦b≦1.0; X and M independently selected from one of Al, Mg, Cu, Zr, Ti, Cr, V, Fe, Mn, Ni, Y, Zn or the combination thereof.

The advantages of the invention include:
(1) the present invention provides a cathode material with novel structure and composition;
(2) the cathode material of the present invention has uniform shell with controlled thickness;
(3) the cathode material has the outermost coating layer which leads to an excellent protection of the cathode material body;
(4) the cathode material of the present invention has the advantages such as high capacity, good cycle performance, low surface activity, high pressure resistance and good security, etc.;
(5) the preparation process of the present invention is simple and suitable for large scale application.

The invention will be further illustrated with reference to the following specific examples. It should be understood that these examples are only intended to illustrate the invention, but not to limit the scope of the invention. The experimental methods in the following examples without particular conditions mentioned are performed under routine conditions or as instructed by the manufacturer.

Unless defined otherwise, all technical and scientific terms used herein have the same meaning as commonly understood to one of ordinary skill. In addition, any methods and materials similar or equivalent to the content with the present method can be applied in the method of the present invention. Preferred embodiments and materials described in the text are used for demonstration purposes only.

### EXAMPLE 1

Preparation of the Cathode Material with LiNi_{1/3}Co_{1/3}Mn_{1/3}O₂ as core and Li[(Ni_{1/3}Co_{1/3}Mn_{1/3})_{0.99}Al₀₀₁]O₂ as Shell

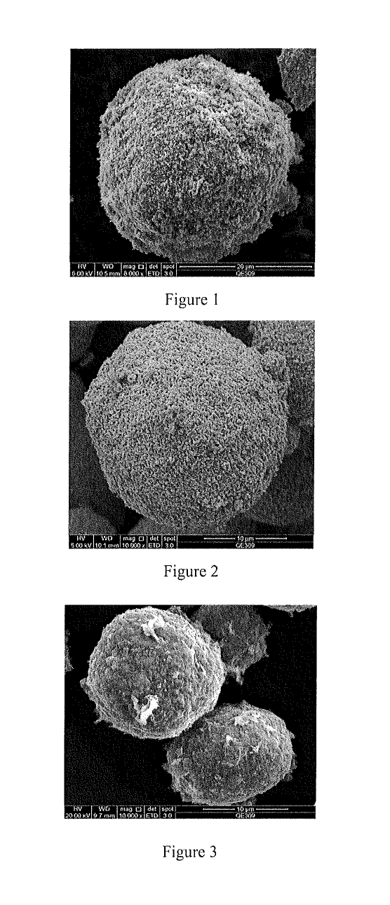

13.3234 g of Al₂(SO₄)₃·18H₂O was weighed and added to 100 g of water to completely dissolve. 18.3083 g of Ni_{1/3}Co_{1/3}Mn_{1/3}(OH)₂ as precursor was added and stirred to form precursor dispersion. Then 2% of NH₃·H₂O was added to completely sediment Al(OH)₃. The pH value at end point was about 9. After NH₃·H₂O was added dropwisely, the reaction mixture was continually stirred for another 60 min and then stopped for filtering. After washed with water twice, the coated precursor was dried at 120° C. for 12 h. The morphology was shown in FIG. 1. The particle size was 1-20 vim. Then lithium hydroxide monohydrate and dry precursor were mixed uniformly in accordance with the mole ratio of 1.10. After the mixture was pre-sintered at 450° C. in air for 5 h, the temperature was increased to 900° C. Then the mixture was calcinated at 900° C. for another 12 h and naturally cooled down to room temperature to obtain an active cathode material, wherein, the surface was Li[(Ni_{1/3}Co_{1/3}Mn_{1/3})_{0.99}Al_{0.01}]O₂ and the internal substrate was LiNi_{1/3}Co_{1/3}Mn_{1/3}O₂, the morphology of which was shown in FIG. 2. The particle size was 1-21 μm and the thickness of the shell was 0.2 μm.

### EXAMPLE 2

Preparation of Cathode Material with LiNi_{0.5}Co_{0.2}Mn_{0.3}O₂ as core and Li[(Ni_{0.5}Co_{0.2}Mn_{0.3})_{0.99}Al_{0.01}]O₂ as Shell

1.4450 g of Al(NO₃)₃·9H₂O was weighed and dissolved in 100 mL water. 10.0420 g of Ni_{0.5}Co_{0.2}Mn_{0.3}(OH)₂ was added to form precursor dispersion. 1% of aqueous ammonia was dropwisely added to adjust pH to about 9.0, concentrated ammonia was continually added to adjust pH to 11 and then stirred for 60 min followed by being filtered and washed with water twice, the coated precursor was dried at 120° C. for 12 h, the morphology of which was shown in FIG. 3. The particle size was 1-20 μm.

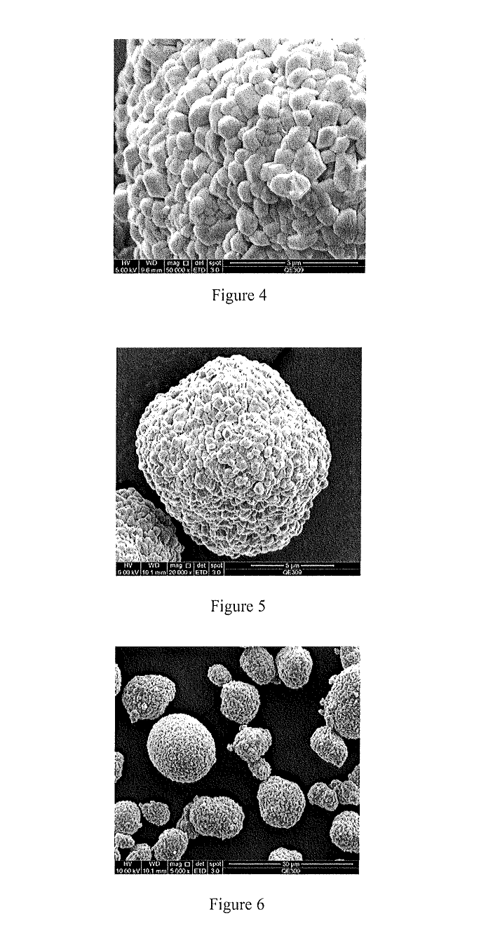

Then lithium hydroxide monohydrate and dry precursor were mixed uniformly in accordance with the mole ratio of 1.10. The mixture was pre-calcinated at 900° C. in an oxygen atmosphere for 12 h and the temperature was naturally cooled down to room temperature to obtain an active cathode material, wherein, the shell was Li[(Ni_{0.5}Co_{0.2}Mn_{0.3})_{0.99}Al_{0.01}]O₂ and the core was LiNi_{0.5}Co_{0.2}Mn_{0.3}O₂, the morphology of which was shown in FIG. 4. The particle size was 1-25 μm and the thickness of the shell was 0.5 μm.

### EXAMPLE 3

Preparation of the Cathode Material with LiNi_{0.5}Co_{0.2}Mn_{0.3}O₂ as core and LiCoO₂ as Shell

1.4411 g of Co(CH₃COO)₂·4H₂O was weighed and dissolved in 100 mL water. 10.0200 g of Ni_{0.5}Co_{0.2}Mn_{0.3}(OH)₂ was added to form precursor dispersion. 1% of aqueous ammonia was dropwisely added to adjust pH to about 9.0, concentrated ammonia was continually added to adjust pH to 11 and then stirred for 60 min followed by being filtered and washed with water twice, the coated precursor was dried at 120° C. for 12 h, the morphology of which was shown in FIG. 5. The particle size was 1-20 μm.

Then lithium hydroxide monohydrate and dry precursor were mixed uniformly in accordance with the mole ratio of 1.10. The mixture was pre-calcinated at 900° C. in an oxygen atmosphere for 12 h and the temperature was naturally cooled down to room temperature to obtain an active cathode material, wherein, the surface was LiCoO₂ and the internal substrate was LiNi_{0.5}Co_{0.2}Mn_{0.3}O₂, the morphology of which was shown in FIG. 6. The particle size was 1-25 μm and the thickness of the shell was 0.5 μm.

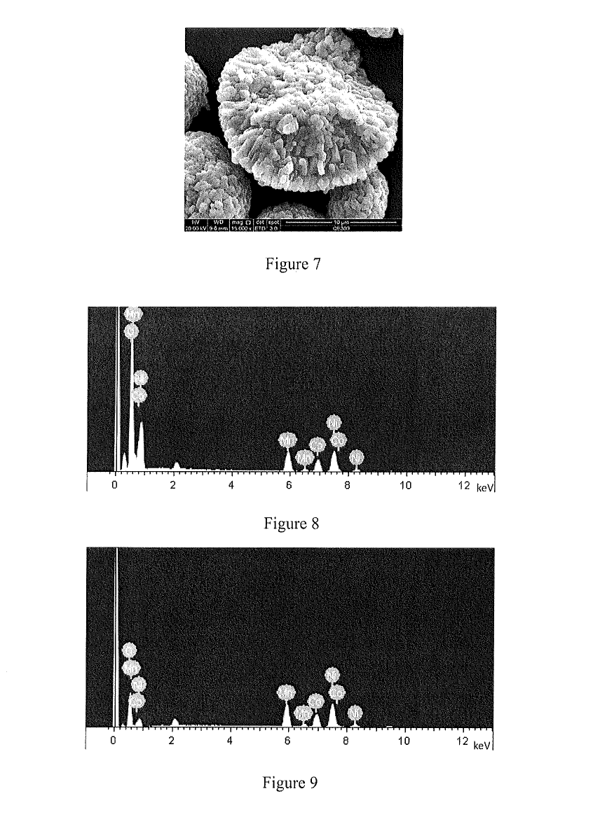

FIG. 7 showed the internal morphology of the cathode material particles. The shell and the core of the core-shell material are comprised of crystalline grain with 0.1-2 μm.

The energy spectrum EDS was used to analyze the shell and the core, and the results were shown in FIG. 8, FIG. 9 and table 1. The amount of Ni in the core was more than that in the shell, and the amount of Co in the core was less than that in the shell.

TABLE 1
The results of EDS element analysis of the shell and the core

| | shell | | core | |
|---|---|---|---|---|
| | mass percent | mole percent | mass percent | mole percent |
| Mn | 15.79 | 7.97 | 20.28 | 13.60 |
| Co | 14.23 | 6.70 | 19.34 | 12.09 |
| Ni | 28.55 | 13.49 | 38.61 | 24.22 |
| O | 41.44 | 71.84 | 21.76 | 50.10 |

### EXAMPLE 4

Preparation of the Cathode Material with LiNi_{0.5}Co_{0.2}Mn_{0.3}O₂ as core, LiCoO2 as shell and Al₂O₃ as Coating Layer

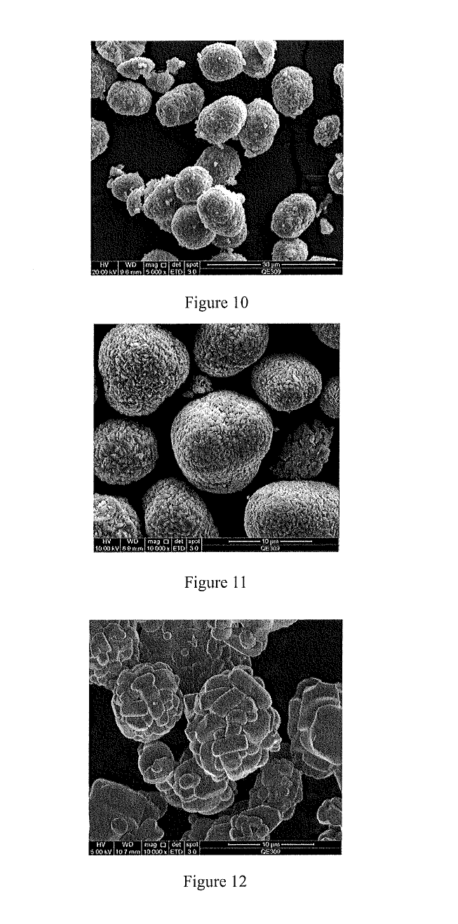

5 g of cathode material prepared in Example 2 was weighed and added to 100 mL of acetic acid-lithium acetate buffer solution with a pH value of 6.0. 0.1 mol/L solution of Al(NO₃)₃ was gradually added and stirred for 30 min. 5% aqueous ammonia was dropwisely added to adjust pH to 8.0 and stirred for 30 min followed by being filtered and washed with water twice, the coated precursor was dried at 120° C. for 12 h and then calcinated at 550° C. for 8 h to obtain an active cathode material, wherein, the surface was Al₃O₂, the shell was LiCoO₂ and the internal substrate was LiNi_{0.5}Co_{0.2}Mn_{0.3}O₂, the morphology of which was shown in FIG. 10. The particle size was 1-25 μm and the thickness of the coating layer was 25 nm.

### EXAMPLE 5

Preparation of the Cathode Material with LiNi_{0.5}Co_{0.2}Mn_{0.3}O₂ as core and LiCo_{0.95}Al_{0.05}O₂ as Shell

5.4360 g of Co(CH₃COO)₂·4H₂O and 0.9097 g of Al(NO₃)₃·9H₂O were weighed and dissolved in 100 mL water. 20.0100 g of Ni_{0.5}Co_{0.2}Mn_{0.3}(OH)₂ was added to form precursor dispersion. 5% of aqueous ammonia was dropwisely added to adjust pH to about 9.0. Then 1 mol/L solution of NaOH was added to adjust pH to 11.0 and stirred for 30 min followed by being filtered and washed with water twice, and the obtained precursor was dried at 120° C. for 12 h, the morphology of which was shown in FIG. 11. The particle size was 1-25 μm.

Then lithium hydroxide monohydrate and dry precursor were mixed uniformly in accordance with the mole ratio of 1.10. The mixture was pre-calcinated at 900° C. in an oxygen atmosphere for 12 h and the temperature was naturally cooled down to room temperature to obtain an active cathode material, wherein, the surface was LiCoO₂ and the internal substrate was LiNi_{0.5}Co_{0.2}Mn_{0.3}O₂, the morphology of which was shown in FIG. 12, The particle size was 1-25 μm and the thickness of the shell was 0.6 μm.

### EXAMPLE 6

Preparation of the Cathode Material with LiNi_{0.5}Co_{0.2}Mn_{0.3}O₂ as Core, LiCo_{0.95}Al_{0.05}O₂ as Shell and MgO as Coating Layer

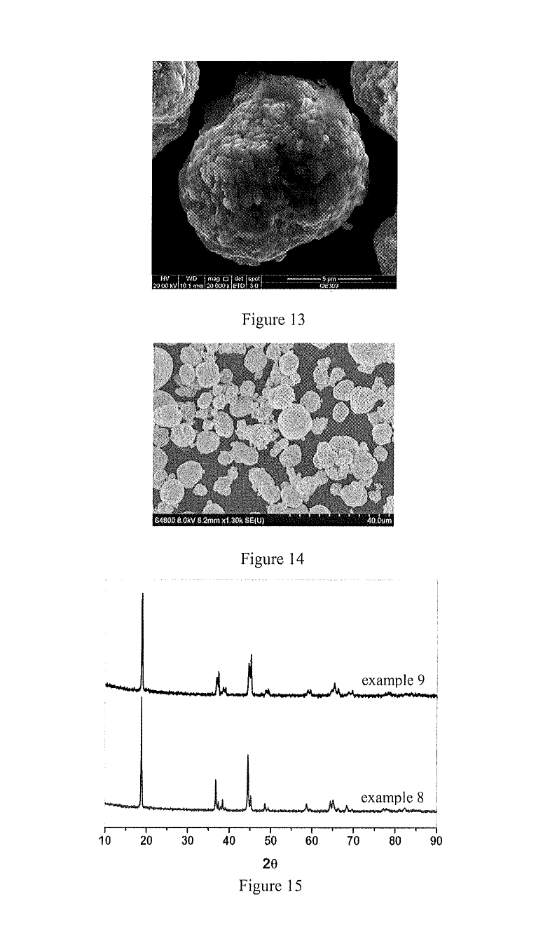

5.0204 g of cathode material prepared in Example 5 was weighed and added to 100 mL water to form dispersion by stirring. 0.1 mol/L solution of MgSO₄ was added. 1 mol/L solution of NaOH was used to adjust pH to 12. The reaction mixture was stirred for 120 min and filtered. After washed with water, the cathode material coated with Mg(OH)₂ on surface was obtained. The cathode material was dried at 120° C. for 10 h and then calcinated at 500° C. for 12 h to obtain an active cathode material, wherein, the surface was MgO, the shell was LiCo_{0.95}Al_{0.05}O₂ and the internal substrate was LiNi_{0.5}Co_{0.2}Mn_{0.3}O₂, the morphology of which was shown in FIG. 13. The particle size was 1-25 μm and the thickness of the coating layer was 30 nm.

### EXAMPLE 7

Co₃O₄ and Ni_{0.5}Co_{0.2}Mn_{0.3}(OH)₂ were mixed uniformly in accordance with the mole ratio of 1:4. The uniform precursor and lithium carbonate were mixed uniformly in accordance with the mole ratio of 1.0:1.1 and calcinated at 900° C. in an oxygen atmosphere for 12 h to obtain the cathode material, which was a mixture of LiCoO₂ and Li[Ni_{0.5}Co_{0.2}Mn_{0.3}]O₂. The morphology of the cathode material was shown in FIG. 14. The particle size was 0.5-25 μm.

### EXAMPLE 8

5 g of the cathode material prepared in Example 7 was weighed and added to 100 mL of acetic acid-lithium acetate buffer solution with a pH value of 6.0. 0.1mol/L solution of Al(NO₃)₃ was gradually added and stirred for 30 min. 5% aqueous ammonia was dropwisely added to adjust pH to 8.0 and stirred for 30 min. After filtered and washed with water twice, the coated precursor was dried at 120° C. for 8 h and then calcinated at 450° C. for 15 h to obtain an active cathode material, wherein, the surface was Al₃O₂, and the cathode material body was a mixture of LiCoO₂ and Li[Ni_{0.5}Co_{0.2}Mn_{0.3}]O₂.

### EXAMPLE 9

Co₃O₄ and Ni_{0.5}Co_{0.2}Mn_{0.3}(OH)₂ were mixed uniformly in accordance with the mole ratio of 1:3. The uniform precursor and lithium acetate were mixed uniformly in accordance with the mole ratio of 1.0:1.1 and calcinated at 950° C. in an oxygen atmosphere for 12 h. The calcinated cathode material was added to 100 mL of acetic acid- sodium acetate with a pH value of 6.0. 0.1 mol/L solution of Al(NO₃)₃ was gradually added and stirred for 60 min. 1% of aqueous ammonia was dropwisely added to adjust pH to 8.0 and stirred for 50 min. After filtered and washed with water twice, the coated precursor was dried at 120° C. for 8 h and calcinated at 450° C. for 12 h to obtain the cathode material, wherein, the surface was Al₃O₂, and the cathode material body was a mixture of LiCoO₂ and Li[Ni_{0.5}Co_{0.2}Mn_{0.3}]O₂.

FIG. 15 was the XRD pattern of the cathode material prepared in examples 8 and 9. The results showed that the intensity of diffraction peak of lithium cobalt oxide in the cathode material increased with the increase of the proportion of the cobalt oxide in the precursor.

### EXAMPLE 10

Preparation of the Cathode Material with LiNi_{0.5}Co_{0.2}Mn_{0.3}O₂ as Core, LiCo_{0.95}Al_{0.05}O₂ as Shell and ZrO₂ as Coating Layer

5.4380 g of Co(CH₃COO)₂·4H₂O and 0.9085 g of Al(NO₃)₃·9H₂O were weighed and dissolved in 100 mL water. 20.0120 g of Ni_{0.5}Co_{0.2}Mn_{0.3}(OH)₂ was added to form precursor dispersion. 5% of aqueous ammonia was dropwisely added to adjust pH to about 9.0. Then 1 mol/L solution of NaOH was added to adjust pH to 11.0 and stirred for 30 min. After filtered and washed with water twice, the obtained precursor was dried at 120° C. for 12 h. The particle size was 1-20 μm.

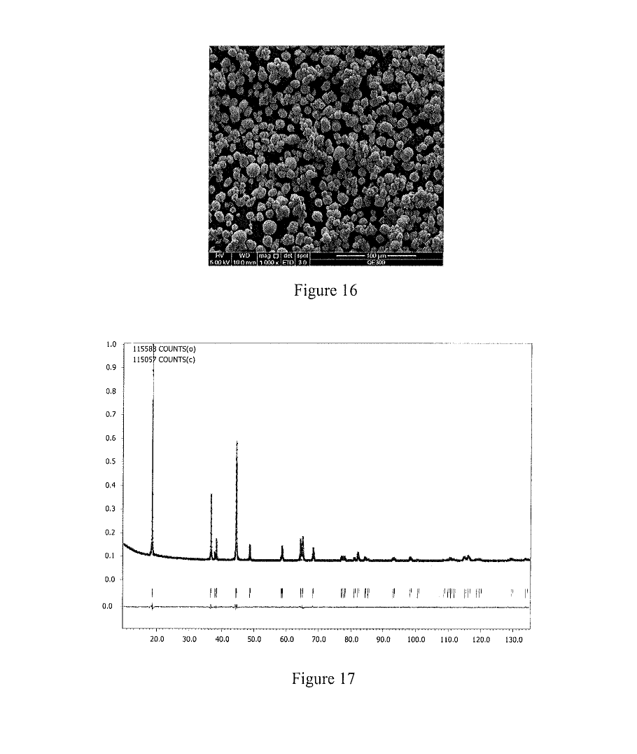

Then lithium hydroxide monohydrate and dry precursor were mixed uniformly in accordance with the mole ratio of 1.10. The mixture was calcinated at 900° C. in an oxygen atmosphere for 12 h and the temperature was naturally cooled down to room temperature to obtain an active cathode material, wherein, the shell was LiCo_{0.95}Al_{0.05}O₂ and the internal substrate was LiNi_{0.5}Co_{0.2}Mn_{0.3}O₂, the morphology of which was shown in FIG. 16. The particle size was 1-25 μm and the thickness of the shell was 0.5 μm.

50 mL of HAc-NaAc buffer solution with a pH value of 5.5 was prepared and the above synthesized cathode material was added to the buffer solution. The 0.1 mol/L solution of Zr(Ac)₄ was added to the buffer solution to gradually sediment Zr(OH)₄. The reaction mixture was stirred for 60 min and filtered. After washed with water three times, the obtained product was placed in a drying oven and dried at 110° C. for 5 h. The obtained product was calcinated at 550° C. for 6 h and then cooled down to room temperature to obtain the cathode material with three layer structure. The diameter of particle was 1-25 μm and the thickness of the shell was 0.5 μm.

### Comparative Example 1

10 g of Ni_{0.8}Co_{0.1}Mn_{0.1}(OH)₂ and 4.74 g of lithium hydroxide monohydrate were weighed and mixed at the mole ratio of Ni_{0.8}Co_{0.1}Mn_{0.1}(OH)₂ and lithium hydroxide monohydrate=1:1.05. The mixture was calcinated in the oxygen atmosphere at 900° C. for 12 h and then cooled down to room temperature to obtain the cathode material.

### EXAMPLE 11

Preparation of the Cathode Material with LiNi_{0.8}Co_{0.1}Mn_{0.1}O₂ as core, LiCoO₂ as Shell

10 g of Ni_{0.8}Co_{0.1}Mn_{0.1}(OH)₂ was weighed and added to NH₃—NH₄OH buffer solution with a pH value of 11. The suspension was heated to 60° C. and stirred for 30 min. 3 g of Co(CH₃COO)₂ was dissolved in 120 mL deionized water. The mixed solution containing 0.5 mol/L LiOH and 1.5 mol/L NH₄OH was prepared. The solution of Co(CH₃COO)₂ and the mixed solution were simultaneously added to the suspension of Ni_{0.8}Co_{0.1}Mn_{0.1}(OH)₂, meanwhile the pH of mixture was kept at 11. After the addition of the solution of Co(CH₃COO)₂ ended, the pH was adjusted to 11.5. The mixture was stirred for 6 h followed by being filtered and dired to obtain core-shell precursor. 10 g of dry precursor and 4.74 of lithium hydroxide monohydrate were weighed and mixed at the mole ratio of precursor and lithium hydroxide monohydrate=1:1.05. The mixture was calcinated in the oxygen atmosphere at 900° C. for 12 h and then cooled down to room temperature to obtain an active cathode material, wherein, the surface was LiCoO₂ and the internal substrate was LiNi_{0.8}Co_{0.1}Mn_{0.1}O₂.

### EXAMPLE 12

10 g of sintered material prepared in example 12 was added to 100 mL of HAc-NaAc buffer solution and stirred. The mixture was heated to 60° C. 10 mL of 0.2 mol/L solution of Zr(NO₃)₄ was added to the mixture. After the addition ended, 1 mol/L of LiOH was added to adjust pH to 9.0. The mixture was stiffed for 12 h followed by being filtered, washed with water three times and dried at 120° C. for 10 h. The dry material was calcinated at 550° C. for 5 h and then cooled down to room temperature to obtain an active cathode material having three layer structure, wherein, the surface was ZrO₂, the shell was LiCoO₂ and the internal substrate was LiNi_{0.8}Co_{0.1}Mn_{0.1}O₂.

Structural Characterization And Performance Measurement

The XRD pattern of the cathode material of example 3 was analyzed and the result was shown in FIG. 17. It can be seen from the analysis result that the cathode material had α-NaFeO₂ structure and the space group thereof was R-3m, wherein, Li occupied 3a position, Ni, Co and Mn occupied 3b position and 0 occupied 3c position. The analyzed cell parameters were as follows. a=b=2.8662, and c=14.2302. In the refined results, Rp=0.99%, Rwp=1.36% and GOF=1.32%.

In N-methyl pyrrolidinone (NMP) solution, each cathode material prepared in examples 1-12 and comparative example 1, respectively, was uniformity mixed with acetylene black as conductive agent and polyvinylidene fluoride (PVDF) as binder, wherein the mass ratio of the cathode material, acetylene black and binder was 90:5:5. Then the homogeneous mixing slurry was coated onto the aluminum foil and dried in vacuum at 120° C. for 12 h to obtain the cathode for lithium ion battery.

CR2032 button lithium ion battery was assembled, wherein above pole piece was used as cathode, metal lithium was used as cathode, 1 mol/L solution of lithium hexafluorophosphate in ethylene carbonate and dimethyl carbonate was used as electrolyte and polyethylene with 20 μm of thickness was used as separator.

Assembled button battery was placed on LAND charge and discharge tester and subjected to charge and discharge test, wherein, the voltage was in the range of 2.8-4.3 V and the charge and discharge current density was 16 mA/g.

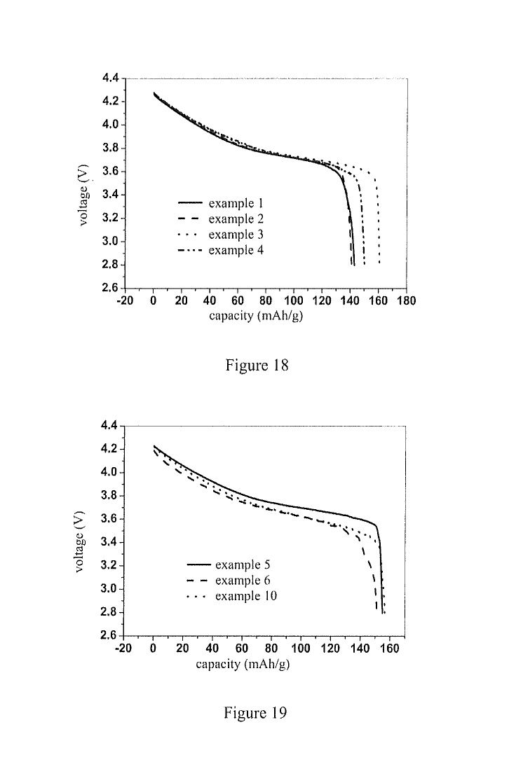

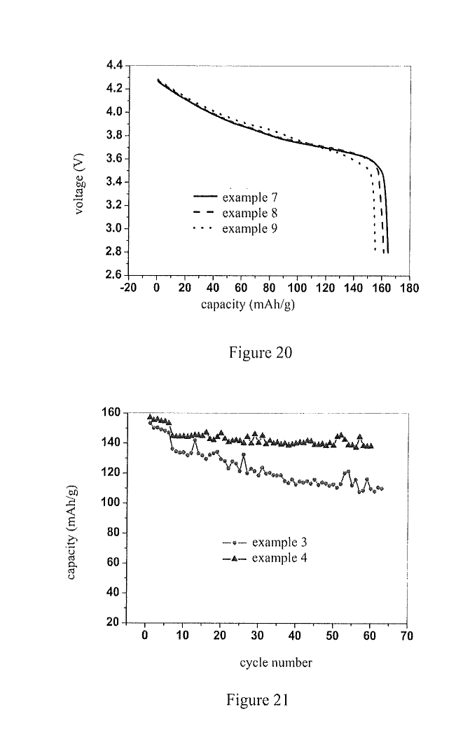

FIGS. 18, 19 and 20 showed the discharge curves of the cathode materials of examples 1-10.

Table 2 showed the initial discharge capacities of the cathode materials of the examples.

The results showed that the capacity of core-shell cathode material is basically identical with that of core material and the capacity of core-shell material coated by oxide is slightly reduced compared to that of core-shell material without oxide layer.

TABLE 2
comparison of the initial discharge capacity

| example | 1 | 2 | 3 | 4 | 5 | 6 | 7 | 8 | 9 | 10 |
|---|---|---|---|---|---|---|---|---|---|---|
| capacity (mAh/g) | 143.1 | 141.1 | 160.8 | 150.2 | 155.0 | 151.3 | 164.6 | 161.5 | 155.4 | 156.6 |

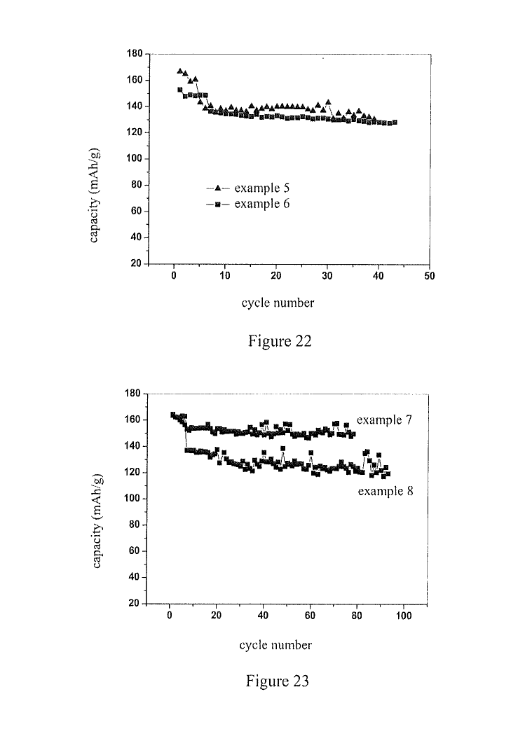

Taking the cathode materials of examples 3-8 for example and comparing the charge and discharge cycle results of the cathode materials with oxide coating layer and those without oxide coating layer, the results were shown in FIGS. 21-23. The results showed that the core-shell cathode materials with oxide coating layer had higher capacity retention ratio and better cyclicity compared to the cathode materials without coating layer.

TABLE 3
comparison of the initial discharge capacity

| | comparative example | example 12 | example 13 |
|---|---|---|---|
| retention rate | 60% | 79% | 90% |
| of 200^{th} cycle | | | |

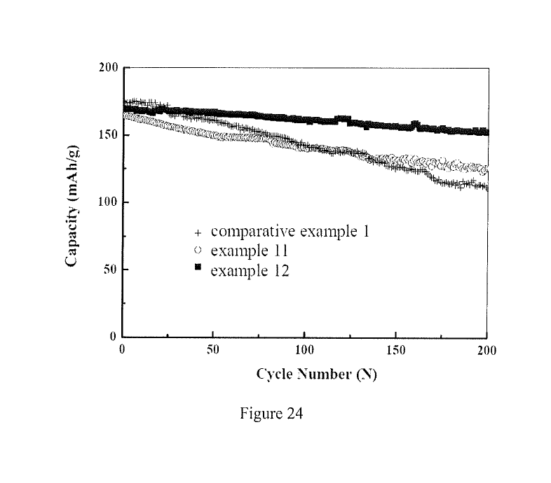

FIG. 24 and table 3 showed that the existence of shell and coating layer significantly increased cycle performance of the cathode material.

All literatures mentioned in the present application are incorporated by reference herein, as though individually incorporated by reference. Additionally, it should be understood that after reading the above teaching, many variations and modifications may be made by the skilled in the art, and these equivalents also fall within the scope as defined by the appended claims.

1. A cathode material comprising of a cathode material body and a coating layer located on the surface of the cathode material body,
wherein, the material of the coating layer is Al₂O₃, ZrO₂, MgO, SiO₂, ZnO, TiO₂, Y₂O₃, LiAlO₂, or the combination thereof;
said cathode material body includes a shell and a core inside the shell, wherein the core material is Li₁₋ₓ[Ni_{1-y-z}Co_{y}Mn_{z}]O₂, wherein, −0.1≦x≦0.2, 0≦y≦0.5, 0≦z≦0.5 and 0≦y+z≦0.7; the shell material is Li₁₋ₐ[Co_{1-b}X_{b}]O₂, wherein −0.1≦a≦0.2, 0≦b≦0.5, and X is Al, Mg, Cu, Zr, Ti, Cr, V, Fe, Mn, Ni, or the combination thereof; or
alternatively said cathode material body is a mixture of Li₁₋ₓ[Ni_{1-y-z}Co_{y}Mn_{z}]O₂ and LiCoO₂, wherein, −0.1≦x≦0.2, 0≦y≦0.5, 0≦z≦0.5 and 0≦y+z≦0.7.

2. According to the cathode material of claim 1, wherein the lattice structures of the core material and the shell material are α-NaFeO₂, and the space groups thereof are R-3m.

3. According to the cathode material of claim 1, wherein the ratio of the thickness of the shell and the radius of the cathode material particular is about 0.005-0.5; and/or the thickness of the coating layer is 0.2-50 nm.

4. According to the cathode material of claim 1, wherein the amount of Ni in the core material is more than that in the shell material, and the amount of Co in the core material is less than that in the shell material.

5. According to the cathode material of claim 1, wherein the core is comprised of crystalline grain with 0.1-5 μm and the shell is comprised of crystalline grain with 0.1-5 μm.

6. A method for the preparation of the cathode material of claim 1 comprising the steps:
(a) precipitating the hydroxide of cobalt or that of X and cobalt on the surface of Ni_{1-y-z}Co_{y}Mn_{z}(OH)₂ to obtain a core-shell precursor P;
(b) mixing the core-shell precursor P with a lithium source at the mole ratio of Li/P=1-1.2 and then sintering the mixture;
(c) precipitating the hydroxide of metal M on the surface of the sintered material;
(d) sintering at 200-1000° C. for 0.5-24 h to obtain the cathode material,
wherein, 0≦y≦1.0, 0≦z≦1.0, 0≦y+z≦1, and 0≦b≦1 .0;
X and M independently selected from one of Al, Mg, Cu, Zr, Ti, Cr, V, Fe, Mn, Ni, Y, Zn or the combination thereof.

8. According to the method of claim 6, wherein in step (c), the sintered sample is placed into a buffer solution, a salt solution of M metal is added and the pH value is adjusted to alkalinity, and the hydroxide of metal M is precipitated on the surface of the sintered sample.

9. According to the method of claim 8, wherein the buffer solution is one of acetic acid-sodium acetate, acetic acid-potassium acetate, acetic acid-lithium acetate, ammonia-ammonium chloride, aqueous ammonia, ammonium acetate-sodium acetate, acetic acid, ammonia-sodium hydroxide, ammonia-potassium hydroxide, phosphate buffer solution, borate buffer solution or the combination thereof, and the pH of said buffer solution is 4.0-14.0.

10. A preparation method of the cathode material of claim 1 comprising the steps:
(a) mixing Ni_{1-y-z}Co_{y}Mn₇(OH)₂ with Co₃O₄ to obtain a core-shell precursor P;
(b) mixing the core-shell precursor P with a lithium source at the mole ratio of Li/P=1-1.2 and then sintering the mixture;
(c) precipitating the hydroxide of metal M on the surface of sintered material;
(d) sintering at 200-1000° C. for 0.5-24 h to obtain the cathode material,
wherein, 0≦y≦1.0, 0≦z≦1.0, 0≦y+z≦1, and 0≦b≦1.0;
X and M independently selected from one of Al, Mg, Cu, Zr, Ti, Cr, V, Fe, Mn, Ni, Y, Zn or the combination thereof.

11. According to the method of claim 10, wherein in step (c), the sintered sample is placed into a buffer solution, a salt solution of M metal is added and the pH value is adjusted to alkalinity, and the hydroxide of metal M is precipitated on the surface of the sintered sample.

12. According to the method of claim 11, wherein the buffer solution is one of acetic acid-sodium acetate, acetic acid-potassium acetate, acetic acid-lithium acetate, ammonia-ammonium chloride, aqueous ammonia, ammonium acetate-sodium acetate, acetic acid, ammonia-sodium hydroxide, ammonia-potassium hydroxide, phosphate buffer solution, borate buffer solution or the combination thereof, and the pH of said buffer solution is 4.0-14.0.

13. A lithium ion battery comprising of the cathode material of claim 1.
